(19) United States
(12) Patent Application Publication
(10) Pub. No.: US 2008/0018968 A1
(43) Pub. Date: Jan. 24, 2008

(54) Planar light source unit

(75) Inventor: Daisaku Okuwaki, Fujiyoshida-shi (JP)

Correspondence Address: BRINKS HOFER GILSON & LIONE, P.O. BOX 10395, CHICAGO, IL, 60610, US

(73) Assignee: Citizen Electronics Co., Ltd.

(21) Appl. No.: 11/825,566

(22) Filed: Jul. 6, 2007

(30) Foreign Application Priority Data
Jul. 10, 2006 (JP) JP2006-189102

(51) Int. Cl. G03H 1/20

(52) U.S. Cl. 359/12

(57) ABSTRACT

A planar light source unit includes a light guide plate having an upper surface, a lower surface, and a peripheral edge surface extending between the peripheral edges of the upper and lower surfaces. A part of the peripheral edge surface is a light-receiving surface, and the upper surface is a light-emitting surface. The upper surface of the light guide plate includes an anisotropic diffusion surface and a smooth flat surface.

This application claims priority under 35 U.S.C. §119 to Japanese Patent Application No. 2006-189102 filed Jul. 10, 2006, the entire content of which is hereby incorporated by reference.

### FIELD OF INVENTION

The present invention relates to a planar light source unit usable, for example, as a backlight unit that illuminates a liquid crystal display panel from behind. More particularly, the present invention relates to a planar light source unit having a light guide plate and a light source, e.g. light-emitting diodes, disposed adjacent to an edge surface of the light guide plate, in which the light guide plate changes the optical path of light from the light source and emits planar light.

A planar light source unit is known as a backlight unit of a liquid crystal display device used in mobile terminal devices, laptop computers, etc. The planar light source unit is arranged, for example, as shown in FIGS. 7a and 7b (see FIG. 17 of Japanese Patent Application Publication No. 2003-337333). As illustrated in the figures, the planar light source unit 120 has LEDs (light-emitting diodes) 102, a light guide plate 101, a diffuser 103, a P_{y} prism sheet 104, a Pₓ prism sheet 105, a reflector 106, and a transmissive or semitransmissive liquid crystal display panel 107.

Light from the LEDs 102 enters the light guide plate 101 through a light-receiving surface 101c thereof and travels in the light guide plate 101 while repeating reflection between an upper surface 101a and a lower surface 101b thereof. The light traveling in this way exits upward from the upper surface 101a, which is a smooth surface. The lower surface 101b is a finely rugged diffuse reflection surface, which reflects the internal light incident thereon toward the upper surface 101a or allows the incident internal light to exit toward the reflector 106. The reflector 106 reflects light exiting the lower surface 101b back into the light guide plate 101, thereby increasing the light utilization efficiency.

Light exiting the upper surface 101a of the light guide plate 101 reaches the diffuser 103 where the light is diffused. Light exiting the diffuser 103 passes through the P_{y} prism sheet 104 whereby the angle formed between light exiting the P_{y} prism sheet 104 and the axis z in the x-z plane is reduced, and then passes through the Pₓ prism sheet 105 whereby the angle formed between light exiting the Pₓ prism sheet 105 and the axis z in the y-z plane is reduced. Thus, the light is directed substantially in the z direction.

The above-described backlight unit suffers, however, from the following problems:

The reflection surface of the lower surface 101b reflects light in various directions. Therefore, light incident on the upper surface 101a include not a few rays that are incident thereon at angles close to the critical angle, as shown in FIG. 7c. Such rays are refracted at angles close to 90° to the normal line, i.e. at angles close to the horizon. In such a case, the rays may fail to reach the diffuser 103. If the rays reach the diffuser 103, because the angle of incidence thereon is large, it is difficult to change the direction of the rays efficiently so that the rays exit the diffuser 103 toward the P_{y} prism sheet 104. Consequently, it is difficult to convert light entering the light guide plate 101 from the LEDs 102 into sufficiently bright illuminating light for the liquid crystal display panel 107.

To solve the above-described problem, a planar light source unit has been developed which uses, as shown in FIG. 8a, a light guide plate 101 provided on its upper surface 101a with a hologram or hairline surface 101h having anisotropic diffusion properties. In this example, a plurality of prisms are provided on the lower surface 101b of the light guide plate 101. The arrangement of the rest of the planar light source unit is substantially the same as that of the planar light source unit 120 shown in FIGS. 7a and 7b. This technique utilizes the publicly known principle as, for example, shown in U.S. Pat. No. 6,347,873 B1 (column 5). That is, an anisotropic diffusion surface 101h similar to a hologram is formed on the upper surface 101a of the light guide plate 101 so that, as shown in FIGS. 8b and 8c, light exiting the upper surface 101a of the light guide plate 101 is diffused by the anisotropic diffusion surface 101h and emitted as diffused light φ₀₁ with a diffusing angle falling in a predetermined angle range. Thus, the problem that the angle of incidence on the diffuser 103 becomes unfavorably large, which has been stated in connection with FIG. 7c, is improved. Consequently, the utilization efficiency of light entering the diffuser 103 can be increased, and the brightness of illuminating light can be enhanced.

Let us explain briefly the operation principle of hologram. A hologram is a record of bright and dark fringes created by interference between object light (light reflected from an object) and reference light. The object light can be reconstructed by applying predetermined light to the hologram even when the object is not present. FIG. 9 shows the principle of hologram. If there are provided object light s_{b} from a point p and reference light sₛ comprising vertical equi-phase parallel rays (laser beam), those lights interfere with one another and, if viewing them on a horizontal plane h, a plurality of bright regions will appear in bilateral symmetry. The spacings of the bright regions gradually decrease with the bright regions being situated farther away from the axis of symmetry. The bright and dark fringe pattern appearing on the plane h in this way is recorded and reconstructed as a hologram H shown in part (b) of FIG. 9 wherein the bright regions are formed as slits. The distances d between respective adjacent slits therefore gradually decrease with the slits being situated farther away from the center of the hologram H.

If, as shown in part (b) of FIG. 9, only equi-phase vertical rays ss are applied to the hologram H, without applying object light s_{b}, the rays sₛ are subject to diffraction at the slits of the hologram H so that rays appear, while exiting the slits at an exit angle θ which is given by:

sin θ=λ/d (1)

where d is the distance between adjacent slits.

In part (b) of FIG. 9, the exit angles θ₁ and θ₂ of light rays from the first and second slits are given by:

sin θ₁=λ/d₁

sin θ₂=λ/d₂
where:
   d₁ is the distance between the first and
   second slits;
   d₂ is the distance between the second and
   third slits.

Because of d₁>d₂, θ₂ is larger than θ₁. Hence, exiting light from the hologram H is diffused.

The diffusion takes place as if light was emitted from an imaginary point p₁ that is in the same positional relationship as the point p relative to the plane h in part (a) of FIG. 9.

FIG. 10 shows a method of producing a hologram in a YZ plane. Part (b) of FIG. 10 shows the operation of the hologram produced by the method shown in part (a) of FIG. 10. The basic principles of the hologram producing method and the hologram operation are the same as those already described in connection with FIG. 9. It should be noted, however, that the slit distances d₁, d₂ and so forth of the hologram H are smaller than in part (b) of FIG. 9, and the exit angles θ₁, θ₂ and so forth of exiting light s_{φ} are correspondingly large in comparison to the hologram H in the XZ plane shown in FIG. 9. Consequently, the diffusion angle of exiting light from the hologram H is larger in the YZ plane than in the XZ plane. In other words, the hologram H functions as an anisotropic diffusion surface.

FIG. 12 shows diffused light φ when a laser beam S_{L} is applied perpendicularly to such an anisotropic diffusion surface H from a laser source L. The diffused light φ is diffused in a bilateral symmetric pattern in the XZ plane, but the A-A section of the diffused light φ taken along a horizontal plane is an ellipse elongated in the Y direction. Thus, the diffused light φ is anisotropically diffused light. The diffused light φ is symmetric with respect to both the X and Y axes.

Such anisotropic diffusion is effective, for example, when light is emitted from the anisotropic diffusion surface 101h on the upper surface 101a of the light guide plate 1001 of FIG. 8 because exiting lights can complementarily fill the gaps therebetween in the Y direction. The symmetry in diffusion of diffused light φ such as that shown in FIG. 12, however, involves some problems. That is, when, as shown in FIG. 13, a laser beam S_{L} is applied obliquely to the anisotropic diffusion surface H from the laser source L, the cross-section of the diffused light φ is, as shown in the B-B sectional view in FIG. 13, not elliptic but of an asymmetric curved shape, which leads to problems as described below.

Let us explain briefly the reason why the cross-section of diffused light becomes such a curved shape. When a laser beam (or equi-phase light rays) perpendicularly impinges on the hologram H, rays of the laser beam arriving at the slits of the hologram H are in phase with each other, and the rays exit from the slits at respective exit angles θ given by Eq. (1). The rays are distributed symmetrically in both the XZ plane and the YZ plane (see FIGS. 9 and 10). However, when the laser beam S_{L} is directed toward the hologram H at an incidence angle α in the XZ plane as shown in FIG. 11, the rays arriving at the slits are not in phase because there is a difference of d·sin α in light paths of the rays arriving at adjacent slits which are spaced apart from each other by a distance d. The exit angle θ of light ray s_{φ} exiting the slit is therefore given by:

sin θ=(λ+d sin α)/d=λ/d+sin α (2)

It will be understood from Eq. (2) that even if there is symmetry in the distances d, no symmetry is found in the exit angles θ of the light rays s_{φ}.

FIG. 11 shows a method of computing the exit angles θ of the light rays s_{φ} with regard to the hologram shown in FIG. 9 when α=30° by using Eq. (2). It will be clear from the figure that there is no symmetry in diffusion at all with respect to the XZ plane.

In the YZ plane, however, rays of the laser beam arriving at the slits of the hologram H are in phase with each other. Therefore, the symmetry of diffused light as shown in part FIG. 10b is preserved.

The B-B section shown in FIG. 13 reveals that the symmetry of the ellipse is lost in the direction B-B. The section of diffused light φ is deformed one-sidedly. In contrast, the symmetry is preserved in a direction (Y direction) perpendicular to the B-B direction. Thus, the B-B section is arcuately curved as a whole.

FIG. 14 shows the luminance distribution of exiting light on the upper surface of the light guide plate 101 having an anisotropic diffusion surface 101h as shown in FIG. 8. In FIG. 14, thinly hatched regions L₁ are where the light intensity is weak although there is light emission, and thickly shaded regions L₂ are high-luminance light-emitting regions (emission lines) that are curved as stated above by anisotropic diffusion. Of the emission lines L₂, those that are close to the LEDs 102 are curved particularly markedly by anisotropic diffusion. The reason for this is that in these regions a large proportion of rays from the LEDs 102 diverge to travel obliquely, and the obliquely traveling rays impinge on the anisotropic diffusion surface 101h.

In FIG. 14, the curved emission lines L₂ shine brightly, and the brightness is low at regions between the curved emission lines. Accordingly, the curved emission lines are conspicuous if they are left as they are, causing the illumination quality to be degraded. Therefore, as shown in FIG. 1, a diffuser 103 and other optical path correcting members such as prism sheets 104 and 105 are disposed to face the upper surface of the light guide plate 101. By so doing, the curved emission lines and the luminance unevenness are improved to a certain extent. It is, however, difficult to satisfactorily improve the curved emission lines near the LEDs and the resulting unevenness in luminance. Thus, the conventional planar light source unit having a light guide plate with an anisotropic diffusion surface on the upper surface thereof has the advantage that the overall quantity of illuminating light can be increased by the anisotropic diffusing effect, but suffers from the problem that the curved emission lines of diffused light and the luminance unevenness cannot be satisfactorily prevented.

### SUMMARY OF THE INVENTION

Accordingly, an object of the present invention is to provide a light guide plate and a planar light source unit that are substantially free from the above-described problems with the related art.

The present invention provides a light guide plate having a first surface, a second surface opposite to the first surface, and a peripheral edge surface extending between the peripheral edges of the first and second surfaces. A part of the peripheral edge surface is a light-receiving surface. One of the first and second surfaces includes an anisotropic diffusion surface and a smooth flat surface.

When light is introduced into the light guide plate through the light-receiving surface and emitted from the one of the first and second surfaces, the gaps (dark regions) between the curved emission lines generated by the anisotropic diffusion surface are complementarily filled with light exiting the smooth flat surface, thereby enabling the planar light source unit to be improved in illumination quality.

The smooth flat surface may be provided near the light-receiving surface. The region of the light guide plate near the light-receiving surface is where curved emission lines are particularly likely to appear. Therefore, the smooth flat surface is provided in this region, thereby avoiding the appearance of curved emission lines.

In addition, the present invention provides a planar light source unit including the above-described light guide plate, a diffuser provided over the one of the first and second surfaces, and a light-collecting member that directs diffused light passing through the diffuser in a direction perpendicular to the one of the first and second surfaces.

In this planar light source unit, the above-described gaps (dark regions) between the curved emission lines are complementarily filled with light from the smooth flat surface, and light from the light guide plate is further converted into illuminating light of uniform luminance through the diffuser and the light-collecting member.

Specifically, a plurality of light-emitting diodes may be provided adjacent to the light-receiving surface in such a manner as to be spaced from each other in the width direction of the light-receiving surface.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a diagram showing the structure of a planar light source unit according to a first embodiment of the present invention.

FIG. 2 is a diagram showing the structure of a light guide plate for use in the planar light source unit shown in FIG. 1.

FIG. 3 is a diagram showing the luminance distribution on the light guide plate shown in FIG. 2.

FIG. 4 is a diagram showing the structure of a light guide plate for use in a planar light source unit according to a second embodiment of the present invention.

FIG. 5 is a diagram showing the operation of the light guide plate shown in FIG. 4.

FIG. 6 is a diagram showing the luminance distribution on the light guide plate shown in FIG. 4.

FIG. 7a is an exploded perspective view showing the structure of a conventional planar light source unit.

FIG. 7b is a side explanatory view showing the path of light in the planar light source unit shown in FIG. 7a.

FIG. 7c is a side explanatory view illustrating light emitted from the light guide plate toward a diffuser shown in FIG. 7b.

FIG. 8a is an exploded perspective view showing the structure of a conventional light guide plate having an anisotropic diffusion surface.

FIG. 8b is a side explanatory view illustrating exiting light from the light guide plate shown in FIG. 8a.

FIG. 8c is a sectional view taken along the line 8c-8c in FIG. 8b.

FIG. 9 is a diagram showing in the left half (a) a method of producing a hologram in an XZ plane and showing in the right half (b) the operation of the hologram thus produced.

FIG. 10 is a diagram showing in the left half (a) a method of producing a hologram in a YZ plane and showing in the right half (b) the operation of the hologram thus produced.

FIG. 11 is a diagram for explaining the reason why curved emission lines are generated in anisotropic diffusion by a hologram.

FIG. 12 is a side view showing the action of an anisotropic diffusion surface on which a laser beam perpendicularly impinges, which also shows a sectional view taken along the line A-A in the side view.

FIG. 13 is a side view showing the action of the anisotropic diffusion surface on which a laser beam obliquely impinges, which also shows a sectional view taken along the line B-B in the side view.

FIG. 14 is a diagram showing the luminance distribution on the light guide plate shown in FIGS. 8a and 8b.

### DETAILED DESCRIPTION OF THE PREFERRED EMBODIMENTS

Embodiments of the present invention will be described below with reference to the accompanying drawings.

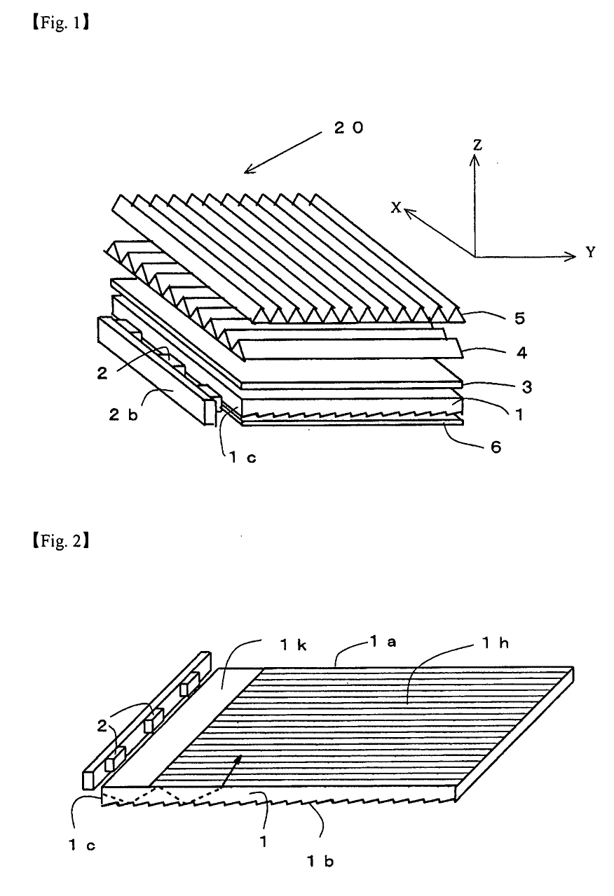

FIG. 1 shows the general structure of a planar light source unit 20 according to a first embodiment of the present invention. In FIG. 1, the planar light source unit 20 includes LEDs (light-emitting diodes) 2, a light guide plate 1, a diffuser 3, a Pₓ prism sheet 4, a P_{y} prism sheet 5, and a reflector 6. The LEDs 2 are mounted on an LED substrate 2b and disposed at a position facing a light-receiving surface 1c of the light guide plate 1. The diffuser 3, the Pₓ prism sheet 4 and the P_{y} prism sheet 5 are stacked successively over an upper surface 1a of the light guide plate 1. The reflector 6 is disposed close to and facing a lower surface 1b of the light guide plate 1. In the illustrated coordinate system consisting of mutually orthogonal x, y and z axes, the y axis is the axis in the longitudinal direction of the light guide plate 1, which is perpendicular to the light-receiving surface 1c. The x axis is the axis in the width direction of the light guide plate 1, which is perpendicular to the y axis. The z axis is the axis in the thickness direction of the light guide plate 1.

FIG. 2 is a perspective view showing the light guide plate 1 and the LEDs 2 of the planar light source unit 20 shown in FIG. 1. As shown in FIG. 2, an anisotropic diffusion surface 1h and a smooth flat surface 1k are formed on the upper surface 1a of the light guide plate 1. The anisotropic diffusion surface 1h may, for example, be a hologram diffusion surface, or a hairline diffusion surface having a hologram-like groove pattern. The smooth flat surface 1k is formed only in a region of the upper surface 1a of the light guide plate 1 that extends over a predetermined distance from the light-receiving surface 1c, i.e. a region of the upper surface 1a close to the LEDs 2. The anisotropic diffusion surface 1h, which is a hologram diffusion surface or a hairline diffusion surface having a hologram-like groove pattern, is formed on the rest of the upper surface 1a of the light guide plate 1. The lower surface 1b of the light guide plate 1 is provided with a plurality of prism surfaces.

Light rays entering the light guide plate 1 through the light-receiving surface 1c travel in the light guide plate 1, and while traveling, the light rays exit upward from the upper surface 1a including the smooth flat surface 1k and the anisotropic diffusion surface 1h. At this time, light from the anisotropic diffusion surface 1h exits as anisotropically diffused light. Light exiting the smooth flat surface 1k is not emitted as diffused light but as ordinary refracted light. Therefore, no curving due to anisotropic diffusion occurs in the cross-section of the light exiting the smooth flat surface 1k.

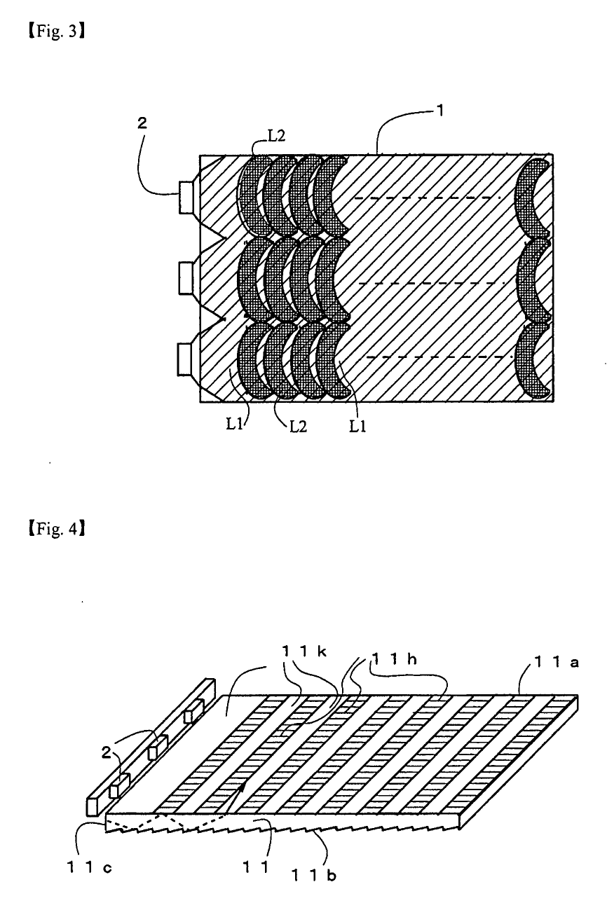

FIG. 3 shows the luminance distribution of light exiting the light guide plate 1 as seen from above (as seen from the vicinity of the upper surface 1a of the light guide plate 1). In the figure, regions L₁ shown by diagonal hatching are where rays are emitted even a little, and thickly shaded regions L₂ are curved emission lines that are conspicuously bright.

In the first embodiment, as shown in FIG. 3, curved emission lines due to anisotropic diffusion are not present at all in a surface portion corresponding to the smooth flat surface 1k in FIG. 2 because ordinary refracted rays exit therefrom. In the other surface portion (corresponding to the anisotropic diffusion surface 1h in FIG. 2), curved emission lines L₂ due to anisotropic diffusion are present, but the degree of curving of the emission lines L₂ is relatively small, and the area of the gaps between the curved emission lines, which provide a low luminance, is relatively small. In this state, light exits upward from the light guide plate 1 and passes through the diffuser 3, the Pₓ prism sheet 4 and the P_{y} prism sheet 5 as illuminating light. Therefore, the direction of exiting light from the light guide plate 1 is corrected, and the luminance nonuniformity is improved. The problem that the curved emission lines due to anisotropic diffusion is also improved to a considerable extent. Thus, it is possible to emit illuminating light of substantially uniform luminance as a whole.

It should be noted that the reflector 6 reflects rays exiting downward from the lower surface 1b of the light guide plate 1 back into the light guide plate 1, thereby increasing the light utilization efficiency in the light guide plate 1.

A second embodiment of the planar light source unit according to the present invention will be explained below with reference to FIGS. 4 to 6. FIG. 4 shows a light guide plate 11 for use in the planar light source unit according to the second embodiment. A smooth flat surface 11k is provided near a light-receiving surface 11c of the light guide plate 11 in the same way as the first embodiment shown in FIG. 2. The light guide plate 11 further has band-shaped anisotropic diffusion surfaces 11h and band-shaped smooth flat surfaces 11k that are alternately provided thereon. In the illustrated example, the width of each smooth flat surface 11k and that of each anisotropic diffusion surface 11h are substantially equal to each other.

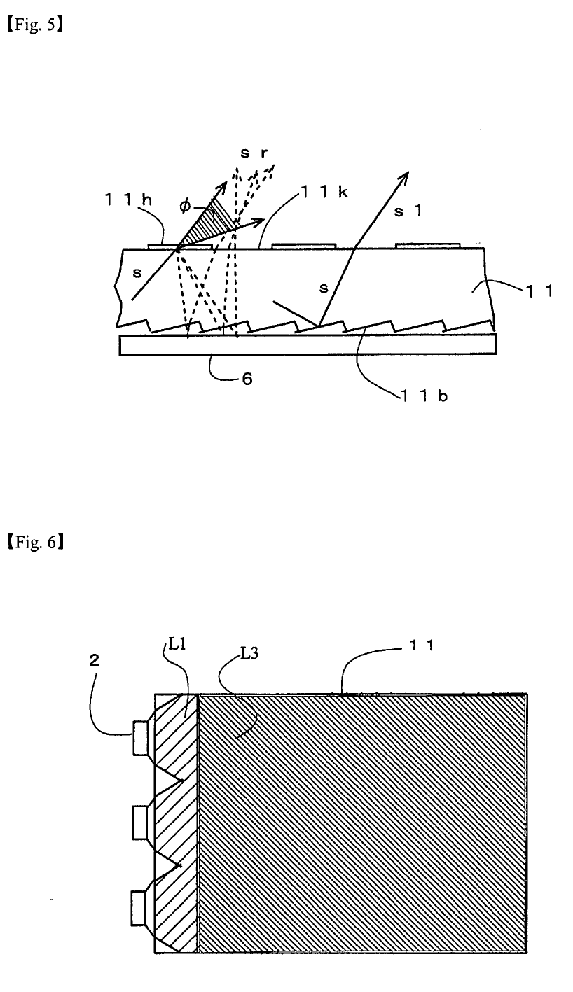

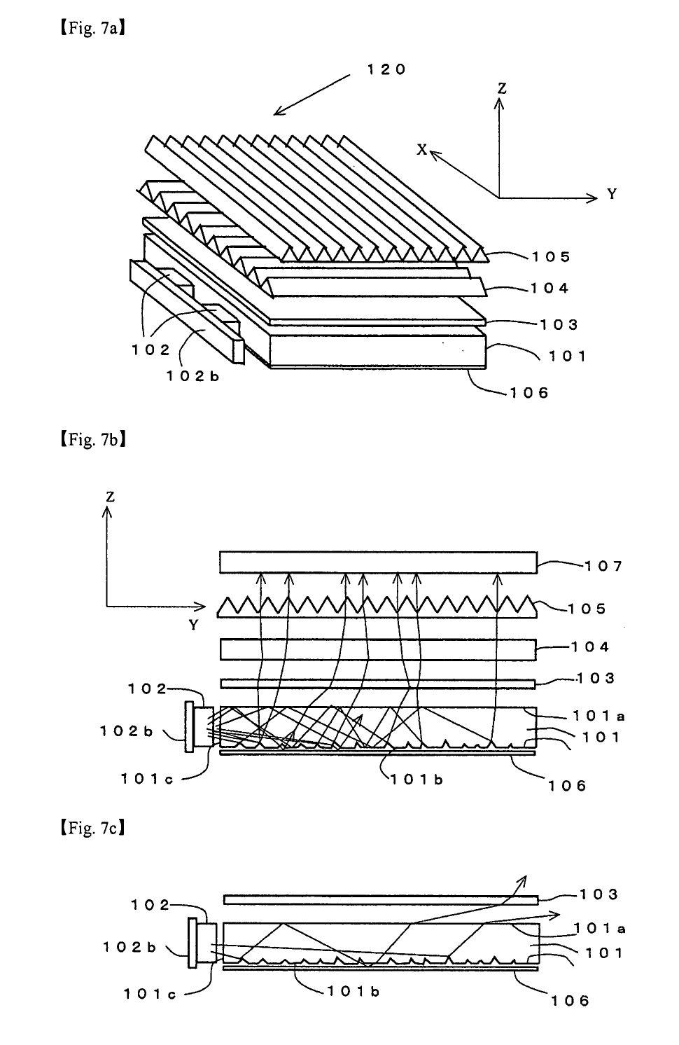

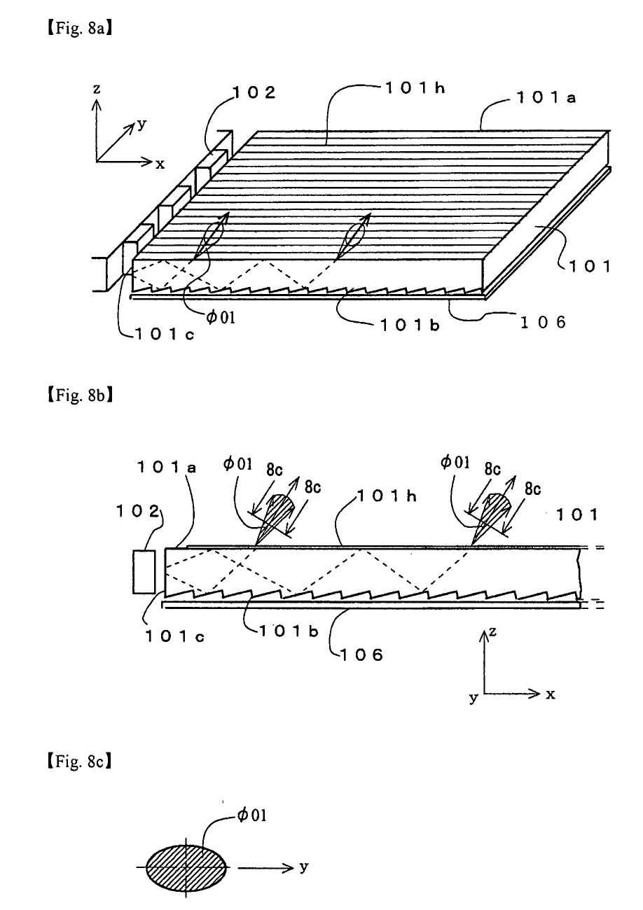

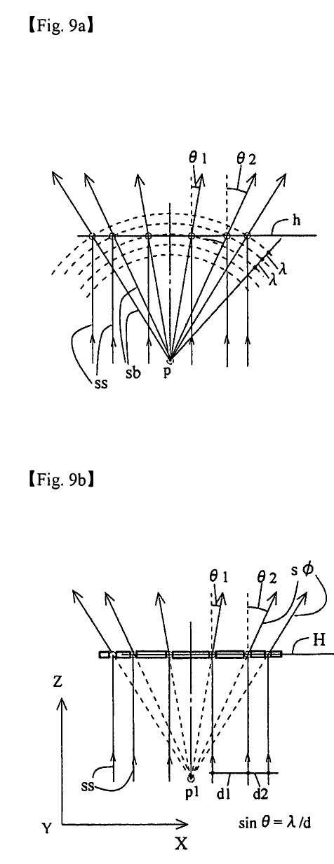

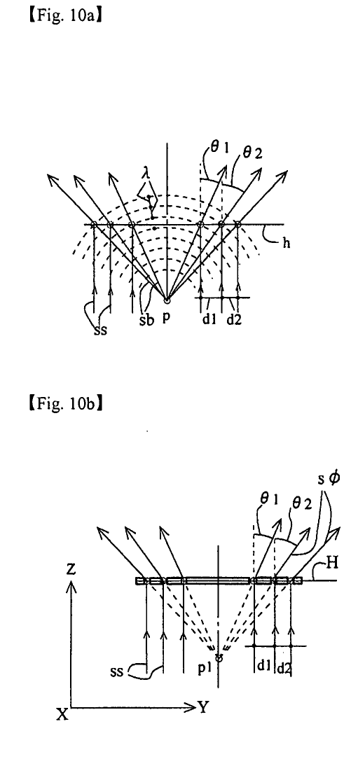

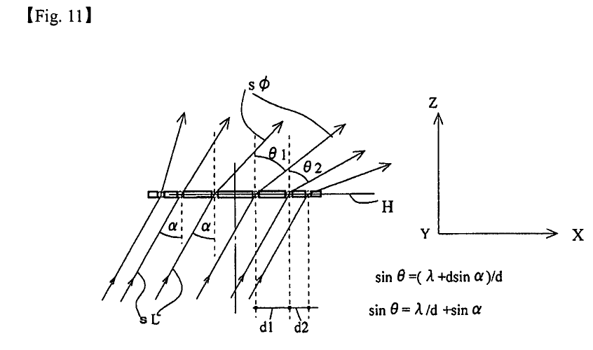

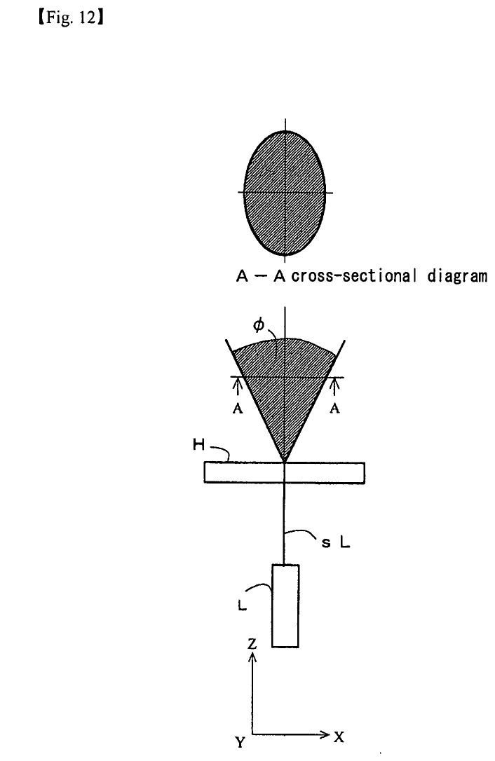

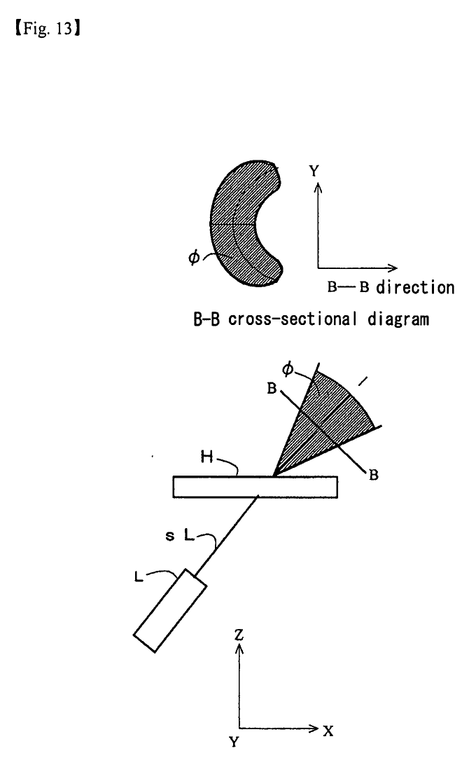

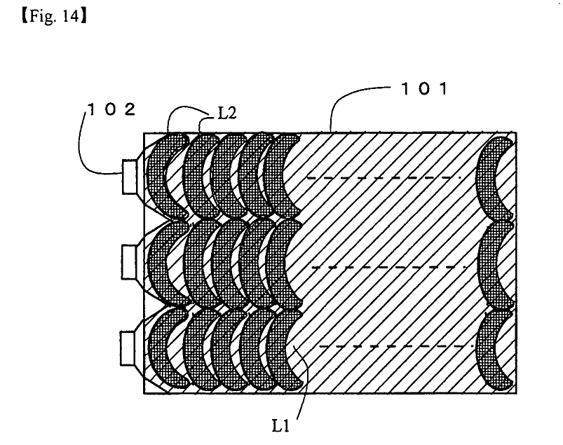

FIG. 5 shows the operation of the light guide plate 11 shown in FIG. 4. When internal light s in the light guide plate 11 is incident on one anisotropic diffusion surface 11h, a part of the incident light becomes diffused light φ, but the remaining light (i.e. light not passing through the slits of the hologram) is diffusely reflected by the anisotropic diffusion surface 11h and may be directed to the neighboring smooth flat surface 11k via the reflector 6 and so forth. As denoted by the dashed lines sᵣ, the light passes through the smooth flat surfaces 11k while being subject refraction. The angles of refraction of the exiting light are distributed over a relatively wide angle range according to the angle of incidence on the smooth flat surface 11k. Accordingly, the exiting light sᵣ can complementarily fill the gaps between the diffused lights φ exiting from the anisotropic diffusion surface 11h. It should be noted that internal light s is also reflected on the lower surface 11b and passes through the smooth flat surface 11k as exiting light s₁. Therefore, the exiting light s₁ complementarily enter the gaps between the diffused lights φ.

The complementarily filling effect of the smooth flat surface 11k can be increased by increasing the ratio of the width of the smooth flat surface 11k to that of the anisotropic diffusion surface 11h. Excessively increasing the width ratio, however, will nullify the characteristic advantage of the anisotropic diffusion surface that can enhance the overall brightness of the planar light source unit. Therefore, it is preferable to set the ratio of the width of the smooth flat surface 11k to that of the anisotropic diffusion surface 11h appropriately in a range within which the brightness enhancing purpose can be attained, thereby compatibly achieving the luminance uniformity of illuminating light and the enhancement of overall brightness of illuminating light.

Although FIG. 4 shows an example in which a plurality of smooth flat surfaces 11k are provided in a belt-like shape, each between a pair of adjacent anisotropic diffusion surfaces 11h, the present invention is not necessarily limited thereto. Smooth flat surfaces 11k of a triangular, quadrangular, circular or other shape may be dispersedly arranged in a zigzag or other pattern between each pair of adjacent anisotropic diffusion surfaces 11h. With this arrangement, the same advantageous effects as the above can be obtained.

FIG. 6 shows the luminance distribution of exiting light from the light guide plate 11 in FIG. 4 as seen from above (as seen from the vicinity of the upper surface 11a of the light guide plate 11). In the figure, a region L₁ shown by coarse hatching corresponds to the smooth flat surface 11k near the light-receiving surface 11c in FIG. 4, where the luminance is relatively low. A region L₃ shown by fine hatching corresponds to the area in which the smooth flat surfaces 11k and the anisotropic diffusion surfaces 11h are mixedly present in FIG. 4, where the luminance is relatively high and the luminance distribution is substantially uniform. In FIG. 6, there are practically no curved emission lines L₂ as shown in FIG. 3. Thus, the light guide plate 11 according to the second embodiment shown in FIG. 4 can satisfactorily eliminate the disadvantage of the anisotropic diffusion surface and can ensure the required intensity of lighting.

It should be noted that the present invention is not necessarily limited to the foregoing embodiments but can be modified in a variety of ways without departing from the gist of the present invention.

1. A light guide plate comprising:
a first surface;
a second surface opposite to said first surface; and
a peripheral edge surface extending between peripheral edges of said first surface and second surface;
wherein a part of said peripheral edge surface is a light-receiving surface, and one of said first surface and second surface includes an anisotropic diffusion surface and a smooth flat surface.

2. The light guide plate of claim 1, wherein said smooth flat surface is provided near said light-receiving surface.

3. A planar light source unit comprising:
said light guide plate of claim 1;
a diffuser provided over said one of said first surface and second surface; and
a light-collecting member that directs diffused light passing through said diffuser in a direction perpendicular to said one of said first surface and second surface.

4. The planar light source unit of claim 3, further comprising:
a plurality of light-emitting diodes provided adjacent to said light-receiving surface, said light-emitting diodes being spaced from each other in a width direction of said light-receiving surface.
